(19) United States
(12) Patent Application Publication
(10) Pub. No.: US 2025/0160558 A1
(43) Pub. Date: May 22, 2025

(54) COOKING POT WITH ROUNDED BOTTOM AND SUPPORT SHROUD

(71) Applicant: Cascade Designs, Inc., Seattle, WA (US)

(72) Inventor: Earl Gaylon Sherrard, Ravensdale, WA (US)

(21) Appl. No.: 18/515,143

(22) Filed: Nov. 20, 2023

(51) Int. Cl. A47J 27/022; A47J 27/00; A47J 36/34

(52) U.S. Cl. CPC A47J 27/022; A47J 27/002; A47J 36/34

(57) ABSTRACT

A cooking assembly for a portable stove that includes a pot having cylindrical vertical sides, an open circular top and a closed rounded bottom and a cylindrical containment ring positioned around a portion of the pot that creates a containment volume between the containment ring and the pot. The containment ring including an open circular bottom configured to interface with a portable stove, to hold the pot in a vertical orientation, and to let flame from the portable stove and air to flow freely into the containment volume so as to reduce back pressure. The containment further including a plurality of vent holes at an upper area of the containment volume configured to let combustion gas escape freely.

### TECHNICAL FIELD

The present disclosure relates to cooking equipment and more particularly to cooking devices designed for outdoor use.

### BACKGROUND

Many outdoor camping stove systems, particularly those carried by backpackers, are designed to have a small size when packed and typically include a cooking pot that tightly contains everything needed to heat water quickly and efficiently, including the stove and the fuel. Such systems are typically designed for heating water and thereafter cooking food, typically freeze-dried meals, for 1-2 people. Such systems typically have a small pot having a diameter of 3.5 in/90 mm that can store a stove and a 4 oz liquid petroleum gas (LPG) fuel canister.

Some so-called “high efficiency” cooking pots used for such stove systems include a flat-bottomed pot that includes a heat exchanger on the bottom of the pot. The atmospheric burner of the stove system draws primary atmospheric air into the stove, mixes it with the fuel, and ignites the fuel/air mixture as it exits the burner, where it mixes with more secondary atmospheric air to complete the combustion process. The resulting flames contact the bottom of the pot and the heat exchanger, which includes fins that are directly in contact with the flames. The interaction between the heat exchanger fins and the flames can disrupt the complete combustion of the flame. Further, as the heat exchanger fins are intended increase the heat at the cooking surface, such pots may limit the stove system's ability to cook foods on low heat or at a simmer. Also, as a slight breeze in an outdoor environment can extinguish the stove's flame when operating at low output, the user may be required to either compensate by increasing the output or constantly reigniting the stove. The heat exchanger fins can also result in too much heat being focused at certain spots, i.e., hot spots, within the pot that correspond to the locations of the fins. Hot spots are created on the cook surface where the fins are thermally connected to the pot. Food can burn at these hot spot locations and make it more difficult to clean the pot after use.

Stove systems with radiant burners use 100% primary air combustion to safely work with a cooking pot that includes a heat exchanger. In a radiant burner system, the flame output lives on the surface of the stove's burner and does not come out of the burner and therefore the flame does not impinge on the fins of the pot's heat exchanger in a way that disrupts combustion. Radiant burner systems have a limited turn-down ratio, which refers to the lowest output at which combustion can be maintained, thus limiting the system's ability to cook food at low heat or at a simmer. Such stove systems can also be expensive. To achieve a slim profile, i.e., stove height, a low weight, and proper combustion at a high output, a thixomolded body, of magnesium or aluminum, that incorporates fuel delivery, jets and horizontal mixer tubes may be required. These requirements further increase the cost over a more standard stove. In addition, since radiant burner stoves are prone to burn back or flash back (an event where the flame propagates inside the stove), a thermal trip may be required to shut off the fuel source, which further adds to the cost of the stove system.

Accordingly, there is a need for an economical, lightweight, and compact stove system that can safely heat water quickly and efficiently while also being able to cook food at low heat settings, including a simmer.

### SUMMARY

A cooking assembly is disclosed that includes a pot having cylindrical vertical sides, an open circular top and a closed rounded bottom and a cylindrical containment ring positioned around a portion of the pot that creates a containment volume between the containment ring and the pot, the containment ring including an open circular bottom configured to interface with a portable stove, to hold the pot in a vertical orientation, and to let flame from the portable stove and air to flow freely into the containment volume so as to reduce back pressure, the containment further including a plurality of vent holes at an upper area of the containment volume configured to let combustion gases escape freely

### BRIEF DESCRIPTION OF THE DRAWINGS

FIG. 1 is a perspective view cooking pot and containment ring in accordance with an embodiment.

FIG. 2 is a cross-sectional side view of a top view along A-A of the cooking pot and containment ring of FIG. 1.

FIG. 3 is a cross-sectional side view of a top view along B-B of the bottom of the cooking pot and containment ring of FIG. 1.

FIG. 4 is a cross-section bottom view of a side view along C-C of the cooking pot and containment ring of FIG. 1.

FIG. 5 is a perspective view of a stove system for heating the cooking pot of FIG. 1.

FIG. 6 is a perspective view and side view of a cooking pot and containment ring having an insulated collar and a handle in accordance with an embodiment.

FIG. 7 is a side view and a cross-sectional side view of a top view along A-A of a cooking pot and containment ring in accordance with an embodiment.

FIG. 8 is a cross-section side view of a side view along B-B of a cooking pot and containment ring in accordance with an embodiment.

FIG. 9 is a cross-section side view of a side view along C-C of a cooking pot and containment ring in accordance with an embodiment.

FIG. 10 is a cross-section side view of a side view along D-D of a cooking pot and containment ring in accordance with an embodiment.

FIG. 11 is a cross-section side view of a side view along E-E of a cooking pot and containment ring in accordance with an embodiment.

FIG. 12 is a cross-section side view of a side view along F-F of a cooking pot and containment ring in accordance with an embodiment.

FIG. 13 is a perspective view and a detailed view of bottom area G of a cooking pot and containment ring in accordance with an embodiment.

FIG. 14 is a perspective view and a cross-section side view of a bottom view along H-H of a cooking pot and containment ring in accordance with an embodiment.

FIG. 15 is a cross-section side view of a side view along J-J of a cooking pot and containment ring in accordance with an embodiment.

FIG. 16 is a cross-section side view of a side view along K-K of a cooking pot and containment ring in accordance with an embodiment.

FIG. 17 is a side view, a perspective view and a detailed view of latch area L of a cooking pot and containment ring in accordance with an embodiment.

FIG. 18 is a side view of the cooking pot and containment ring of FIG. 17.

FIG. 19 is a cross-section side view of a top view along M-M, a perspective view and a detailed view of bottom area N of a cooking pot and containment ring in accordance with an embodiment.

FIG. 20 is a cross-section side view of the side view along P-P and a cross-section top view of a side view along R-R of a cooking pot and containment ring in accordance with an embodiment.

FIG. 21 is a side perspective view of a stove having mounts that interface with the containment ring and legs that may interface with a pot or be retracted, in accordance with an embodiment.

FIG. 22A is a top perspective view of a stove having mounts that interface with the containment ring, the supports having legs that are retracted, in accordance with an embodiment.

FIG. 22B is a blown-up view of the area F in FIG. 22A.

FIG. 23 is a top perspective view of a stove having mounts that interface with the containment ring, the mounts having legs that are extended, in accordance with an embodiment.

FIG. 24 is a bottom perspective view of a pot interfacing with the legs of the mounts.

### DETAILED DESCRIPTION OF ILLUSTRATIVE EMBODIMENTS

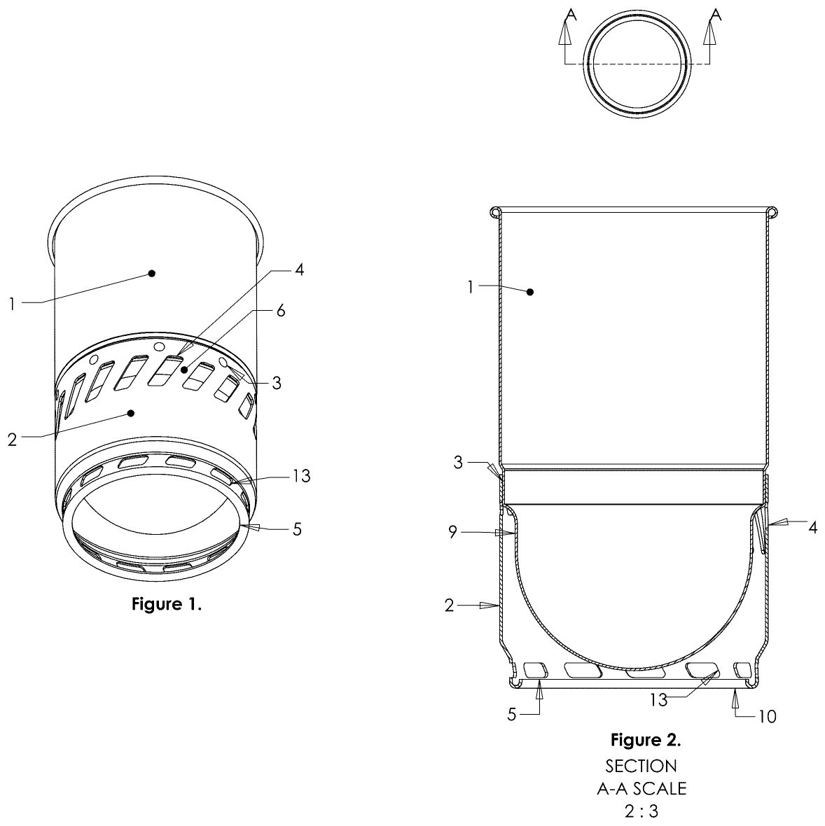

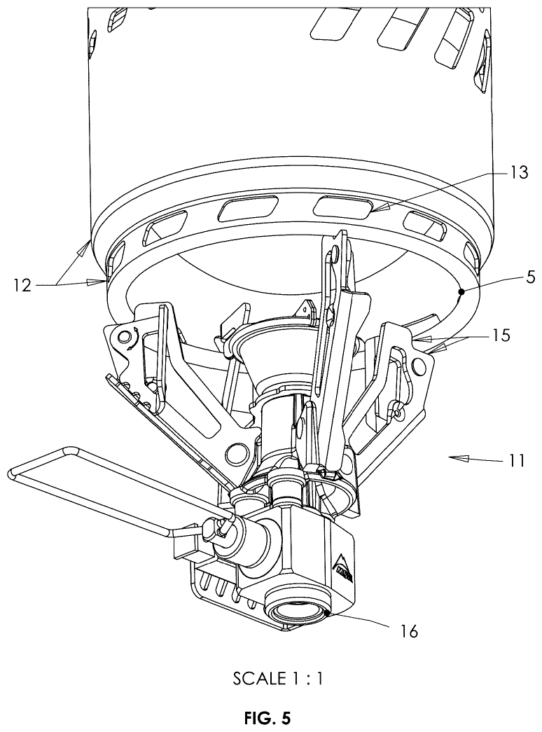

FIG. 1 illustrates a perspective view of a cooking pot 1 for a portable stove 11 (as shown in FIG. 5), preferably a camping or hiking/backpacking stove where the stove system is designed to be stored at least partially inside the pot when not in use. The cooking pot 1 may have a cylindrical upper portion forming vertical sides and a hemispherical or rounded bottom 9, as shown in the side view of FIG. 2, and a shroud or cylindrical containment ring 2 around the cooking pot 1 that helps to contain flame and manage heat and exhaust around the cooking pot. The containment ring 2 may surround at least a region of the bottom 9. The containment ring 2 may be thermally and structurally connected to the pot 1 by a series of welds 3 around the containment ring 2. In embodiments, the containment ring 2 need not be thermally connected to the pot 1, however, if it is not, the heat added to the containment ring 2 may be poorly utilized to heat the water in the pot, thereby reducing the efficiency of the stove 11. Further, the welds need not be welds but rather physically tight compression points between the containment ring 2 and the pot 1.

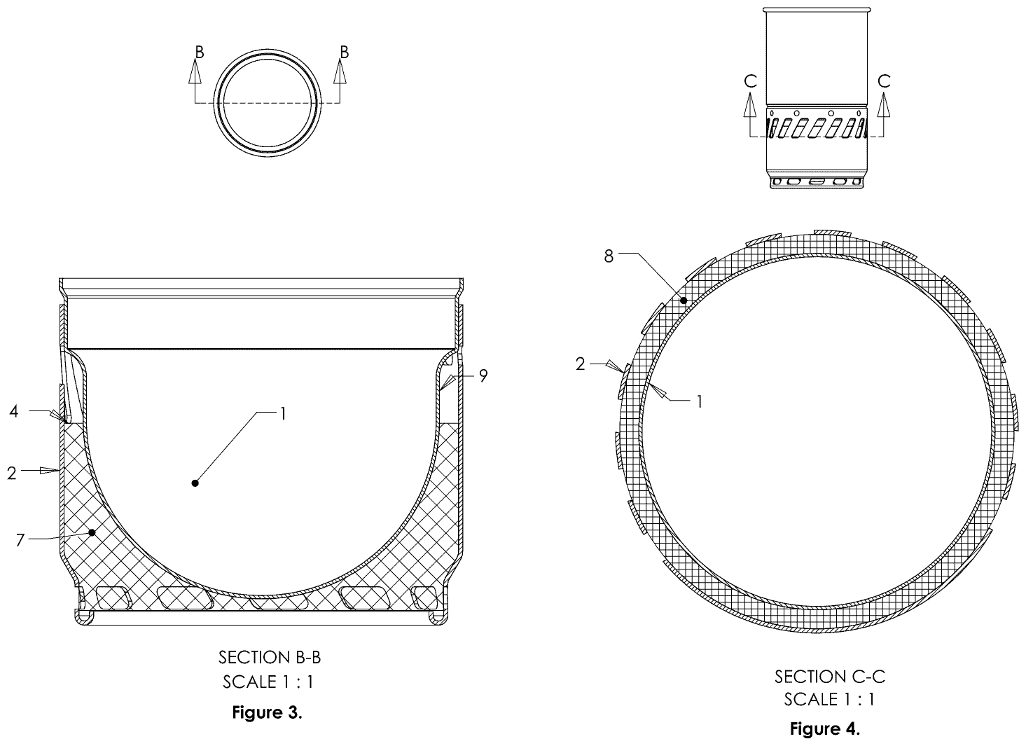

There may be a containment volume 7, as shown by the hashed lines of FIG. 3, between the interior of the containment ring 2 and the pot 1, to enable the flames of the stove burner to achieve proper combustion. Vent holes 4 formed near the top of the containment ring 2 have enough of an open area to let combustion gases escape freely, and collectively with the opening 5, as further explained below, may avoid back pressure that can result in the flame and atmospheric air not fully entering the opening.

The vent holes 4 between the bottom 9 of the pot 1 and the containment ring 2 allow combustion gas in the containment volume 7 to exit at the top of the containment ring 2. As noted above, the addition of a sufficiently large opening 5 in the bottom of the containment ring 2 permits flame from the stove burner and atmospheric air to flow freely into the containment volume 7. It should be noted that if there is too much back pressure in the containment volume 7, the bulk of the flame and air will not fully enter the bottom of the ring through the opening 5, thereby causing the flame and air to stagnate or be trapped and flow back out and around the bottom entrance 5 of the ring. This can disrupt combustion and greatly reduce the efficiency of the stove system, thereby greatly increasing boil time. For a backpacker, where winds are common, it is highly desirable to have the most efficient stove system to reduce the weight of the fuel needed and so the boil time is as low as possible.

The webs 6 of the containment ring 2 formed between each of the holes 4 may need to be far enough from where flame from the stove impinges the bottom 9 of the pot 1 so the webs 6 do not impinge the flame. Impinging the flame at the webs 6 may disrupt the combustion reaction, thereby causing unsafe levels of carbon monoxide (CO). The webs 6 need to have sufficient cross section so as to enable sufficient heat transfer from the containment ring 2 material below the webs 6 to the welds 3 above the webs 6. Likewise, the thermal connection between the containment ring 2 and the pot 1 must also provide sufficient heat transfer so as to fully take advantage of the containment ring 2 being thermally connected, thereby increasing thermal efficiency, and in some cases to prevent the containment ring 2 from getting too hot. The containment ring 2, along with its opening 5, also allows for the pot 1 to be set down on its rim 10 without falling over and allows it to be put on the top of a stove 11.

In order to maintain an overall stove system with a small-packed size, as partly illustrated in FIGS. 3 and 4, the pot 1 may have a stepped diameter along the sides that creates an annular space 8 near the top of the containment volume 7. There is a balance between the size of the annular space 8 and the hemispherical surface area of the pot 1. If the annular space 8 is too large, it may allow for a higher stove output because more flame and heated air surround the pot 1, but it can reduce the hemispherical surface area of the pot exponentially because A=2πr². This reduces the heat transfer into the water in the pot 1, thereby lowering efficiency and increasing boil time. Conversely if the annular space 8 is too small, the hemispherical surface area of the pot increases exponentially, but the flow area around the pot 1 is decreased, which can disrupt combustion and slow the boil time.

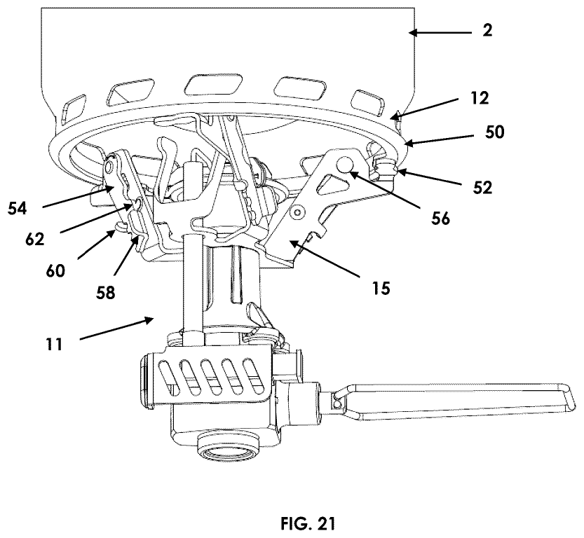

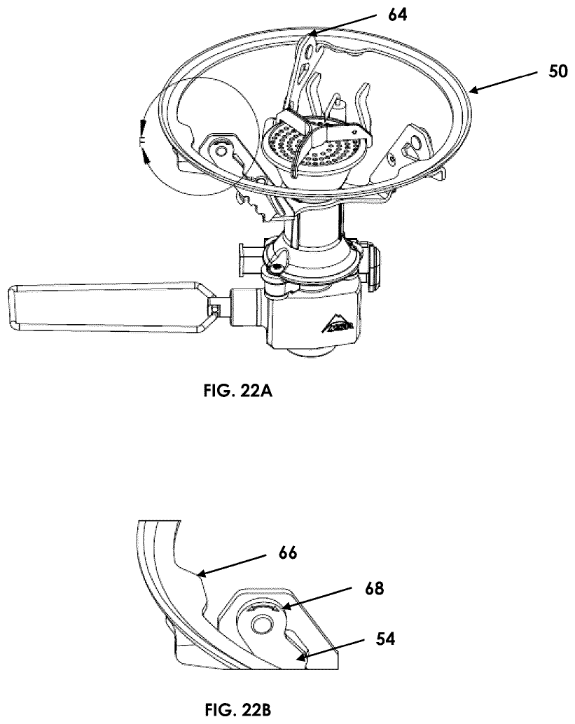

As shown in FIG. 5, the stove 11 may include a plurality of mounts 15 that interface with the containment ring 2. Each of the mounts 15 may include a leg 54 (as shown in FIG. 21) that can extend to provide an interface for a different type of pot, as further illustrated in FIGS. 21-24. Since the stove 11 is designed to fit inside the pot 1 when stored and the mounts 15 themselves (not the legs) do not fold, this limits the size of all of the components. One sizing accommodation involves stepping down the diameter of the containment ring 2 at the ring bottom 12. This step down reduces the size of the bottom opening 5 and therefore reduces the size of the mounts 15. To avoid reducing the stove output and to account for this reduction in the bottom opening 5, additional openings 13 are added in the region of the ring bottom 12 which allow more air to enter.

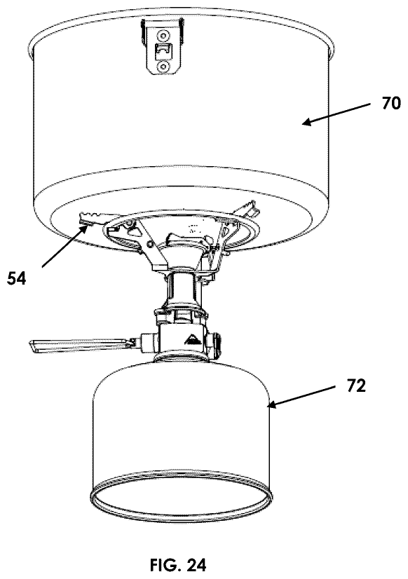

The pot interface/mounts 15 do not fold such that they purposely interface with the pot 1 so as to reduce user interaction in deploying and storing the stove 11 within the pot 1. When stored, the mounts, burner and fuel canister of the stove are designed to fit within or at least partially within the pot; and when in operation, are assembled under the bottom of the pot. However, when the stove system is intended to be used with cookware other than the pot 1, the mounts 15 include legs 54 that can fold out and be used to support the other cookware. The stove 11 also includes a threaded interface 16 for coupling with the LPG fuel canister 72 (as shown in FIG. 24).

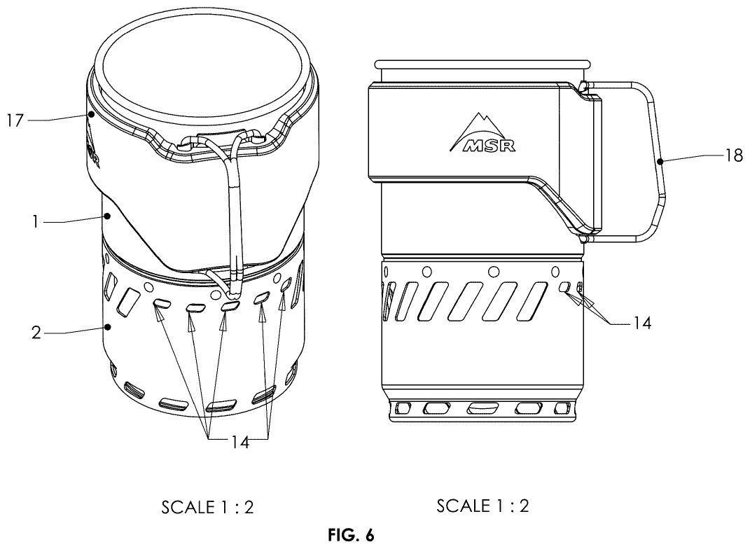

As illustrated in FIG. 6, the pot 1 includes an insulated collar 17 that surrounds the pot 1 and a handle 18 that enables the user to pick up the pot. There are also a number of holes 14 at the upper portion of the containment ring 2 under the handle 18 that reduce back pressure in the area of the containment volume 7 under the handle 18. The holes 14 are sized so there is not too much exhaust gas exiting from the holes near the top of the containment ring 2, which can make the handle 18 too hot for a user to grab while the stove is operating. If there are no holes 14 at the top of the containment ring 2 under the handle 18, there may be back pressure in that segment of the pot 1. Because of that back pressure, the flame may not travel very far up the inside of the containment volume 7 in that area. This also has the effect of reducing the surface area of the pot being heated, resulting in less efficiency and slower boil time, and causing too much back pressure, resulting in insufficient flame and air to enter the bottom of the ring 5 causing incomplete combustion. By adding the holes 14, it also increases the surface area of the pot 1 being heated, thereby speeding up boil time and increasing efficiency. Also, as a result of the holes 14, there may be a lower amount of exhaust gas exiting the holes 14 such that it is cool enough for the user to comfortably grab the handle 18 during operation of the stove.

As noted herein, the fuel/primary air mixture is combusted as it exits the burner where it mixes with secondary air completing the combustion reaction. The chemical reaction of combustion is still occurring while the flame is traveling along the pot bottom. If the pot is relatively smooth and far enough away from the burner, the bulk of the combustion reaction is not disturbed, such as by the fins of a heat exchanger, and thus the combustion products have low CO. Replacing a flat bottomed pot with a hemispherically shaped pot allows the flame to enter the opening 5 in the bottom of the containment ring 2, create volume for combustion, and increase the surface area in contact with the flame, thereby enabling a fast boil that is more efficient.

The hemispherical shape of the pot also reduces the amount of welds that are required, thereby making it less expense to manufacture the stove system. Pots that have heat exchangers consisting of an array of fins usually have the fins welded or brazed to the pot. Such fins may include a corrugated heat exchanger ribbon that is typically welded between each corrugation.

In addition to requiring more welds and potentially leading to more CO caused by the flames' interaction with the fins, so-called “high efficiency” stove systems produce intense heat at the bottom of the pot, which may produce a fast water boil, but also makes it difficult to cook food at a low temperature or simmer. The combination of the hemispherical pot 1 and containment ring 2, however, cooks more like a normal cooking pot which makes it possible to cook at lower temperatures, including a simmer. If there is a breeze, the output of the stove can be increased without overheating the cooking surface. By allowing combustion to occur at the bottom of the pot and the containment volume 7 around a portion of the side, the localized hot spots created by excessive heat being generated at the welds between the heat exchanger fins and the pot, are eliminated. This reduces food burning and sticking to the bottom of the pot, thereby making the pot easier to clean. As the welds between the containment ring 2 are much higher along the side of the pot 1, as long as the food volume is below those locations, food may not stick to the pot 1.

For typical high efficiency stove systems, the burner typically produces a vertical, small diameter flame so that the burner puts as much heat in the center of the pot as possible so as to maximize dwell time of the flame and to exhaust gas as it travels outward along the bottom of the pot. With flat bottomed pots, the higher the surface area (up to a point) the higher the efficiency of the pot. If the flame is too large on a small diameter, flat bottomed pot, the flame will simply shoot outward past the pot diameter and the energy contained in the unutilized flame will be wasted, thereby reducing efficiency.

With a hemispherical pot, there is two times as much surface area relative to the planar circle of a traditional flat bottom pot. This significantly increases the contact time between the flame and hot exhaust gas, which decreases boil time and increases efficiency. In addition, flame directed at the center of a hemisphere follows the bottom to the sides, instead of shooting outward past the bottom of a flat-bottomed pot. Since the flame and exhaust gas follow the shape of the hemisphere up the sides, it further increases its flame contact area, thereby boiling water faster and increasing efficiency, when compared to a flat bottom pot.

A cauldron has a hemispherical bottom, but no containment ring. By adding a containment ring to a cauldron, prolonged heat input is enabled, while reducing boil time and efficiency, and also enabling the hemispherical bottom to sit on a flat surface and not fall over. In addition, as the containment ring 2 is made from a conductive material and is thermally connected to the pot 1, it collects heat from the flame and hot exhaust gas through radiation and convection and transfers that heat through conduction to the pot 1, and therefore its contents. Alternatives to welding the containment ring to the pot include brazing, shrink-fitting or clamping of the containment ring 2 to the pot 1, each of which may also be thermally connect the ring to the pot.

As noted herein, the pot 1 is make from a conductive material. Ideally, the pot 1 is constructed of thin, low density, high thermal conductive material with lower heat capacity and lower specific heat, such as aluminum, which reduces the losses and has a high heat transfer rate. It also reduces the weight of the stove and pot combination. Further, if the pot 1 is darker in color, such as anodized aluminum, it will have a higher emissivity and therefore adsorb more electromagnetic radiation in the form of heat. In other words, the darker colored pot material will collect more heat, in the form of light given off from the flame or anything else that is hot. This is true even for hot objects that do not emit visible light because heat transfer can still occur through radiation, such as from infrared light.

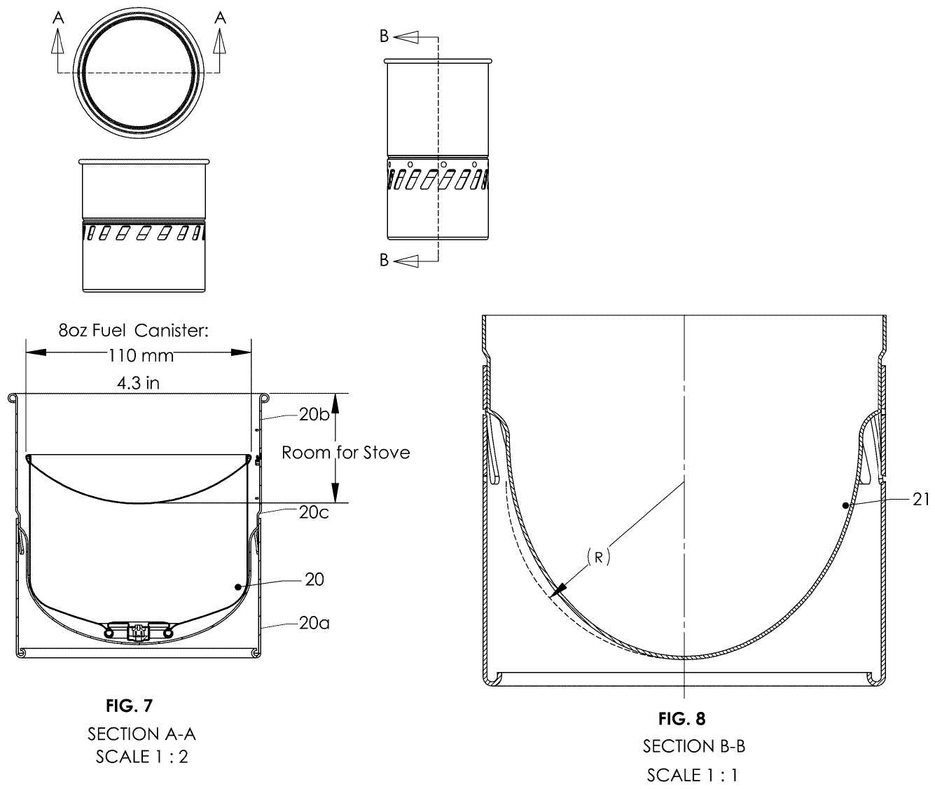

Although the pot has been described herein as hemispherical, other shapes may achieve similar results in terms of boil time and efficiency, including ellipsoidal, paraboloid, or combinations of radii or shapes which generally create a round pot that allows flames and hot exhaust to transfer heat along its bottom and sides and when combined with a containment ring 2 are still highly efficient and safe. A number of embodiments are provided in FIGS. 7-20.

As noted above, the pot 1 may be designed for a stove system using a 4 oz LPG fuel canister. The pot illustrated in FIG. 7 is part of a stove system designed for an 8 oz LPG fuel system. 8 oz LPG fuel canisters have a larger diameter, such as 4.3 in/110 mm fuel canister. Accordingly, the pot 20b in FIG. 7, shown from a top view and a cross-sectional view along A-A, illustrates a larger pot 20b than pot 1 that has more of a parabolic-shaped bottom instead of the more even, half-circular, radius of pot 1. The containment ring 20a is illustrated holding the canister 20 when the canister is stored for travel. As noted, there would still be room for the stove (not shown) between the canister and the top of the pot 20b when the stove is also stored for travel. The pot 20b includes a step down 20c in the diameter of the pot 20b so that a bottom portion of the pot 20b fits within the upper portion of the containment ring 20a. Vent holes are formed below the step down therebetween.

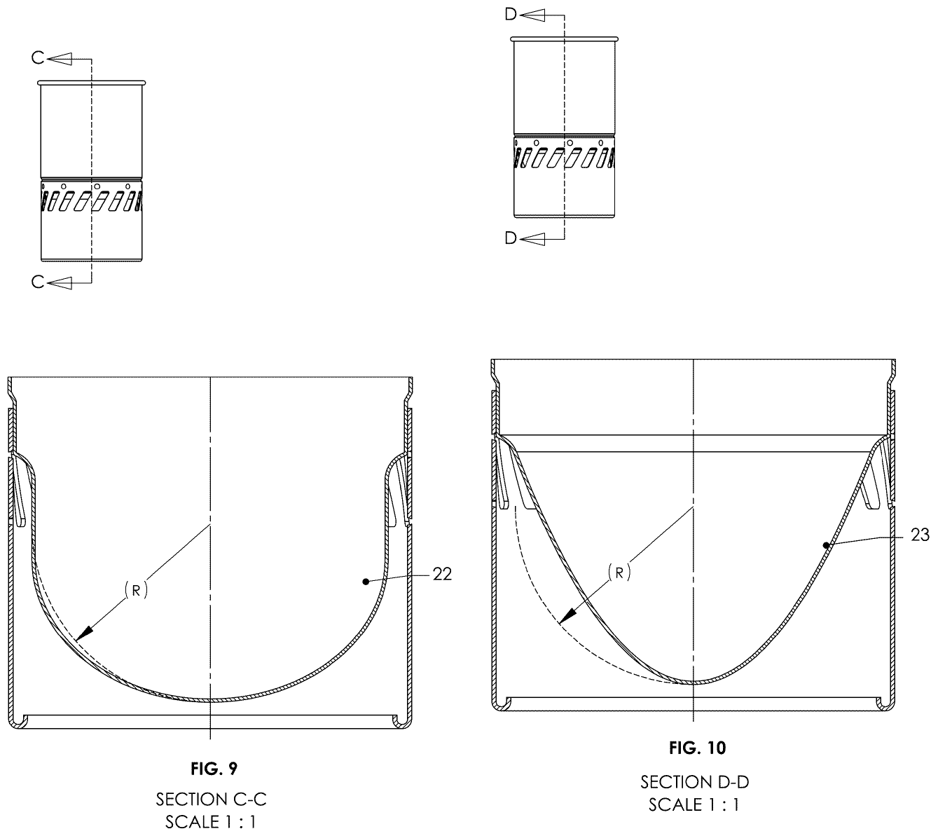

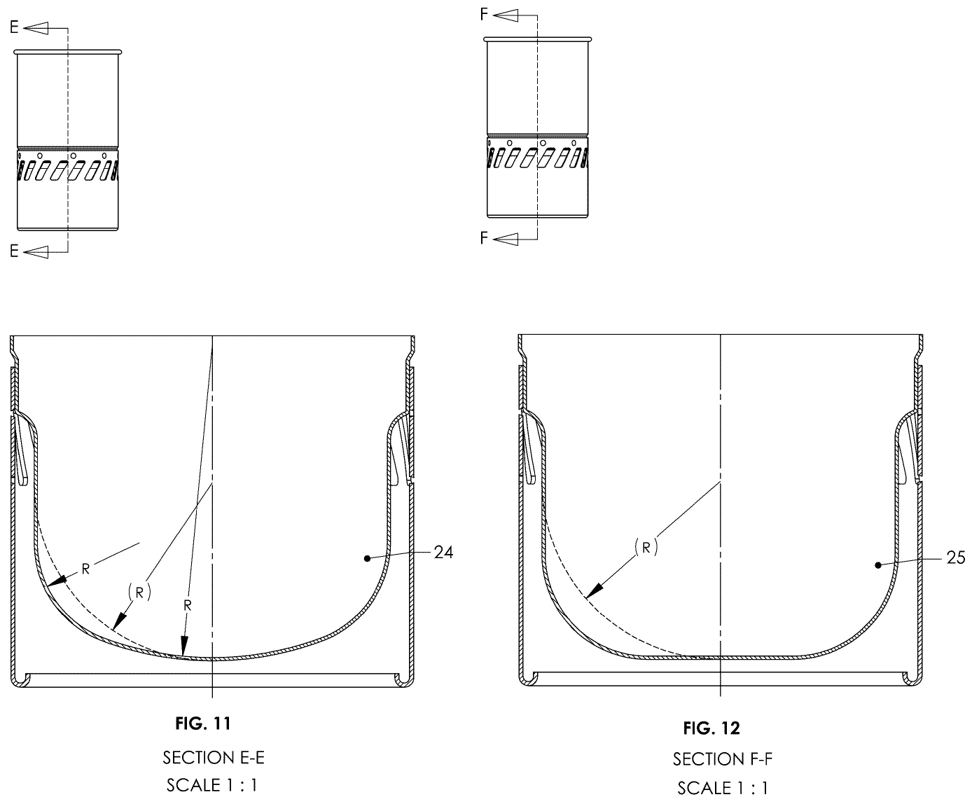

Additional pot shapes are illustrated in FIGS. 8-12. The pot 21 in FIG. 8, from a side view and a cross-sectional view along B-B, and the pot 22 in FIG. 9, shown from a side view and a cross-sectional view along C-C, have elliptical shapes, the pot 23 in FIG. 10, shown from a side view and a cross-sectional view along D-D, has more of parabolic shape, the pot 24 in FIG. 11, shown from a side view and a cross-sectional view along E-E, has more of a multiple radii shape, and the pot 25 in FIG. 12, shown from a side view and a cross-sectional view along F-F, has a small flat area in the center with rounded edges as it transitions to the side.

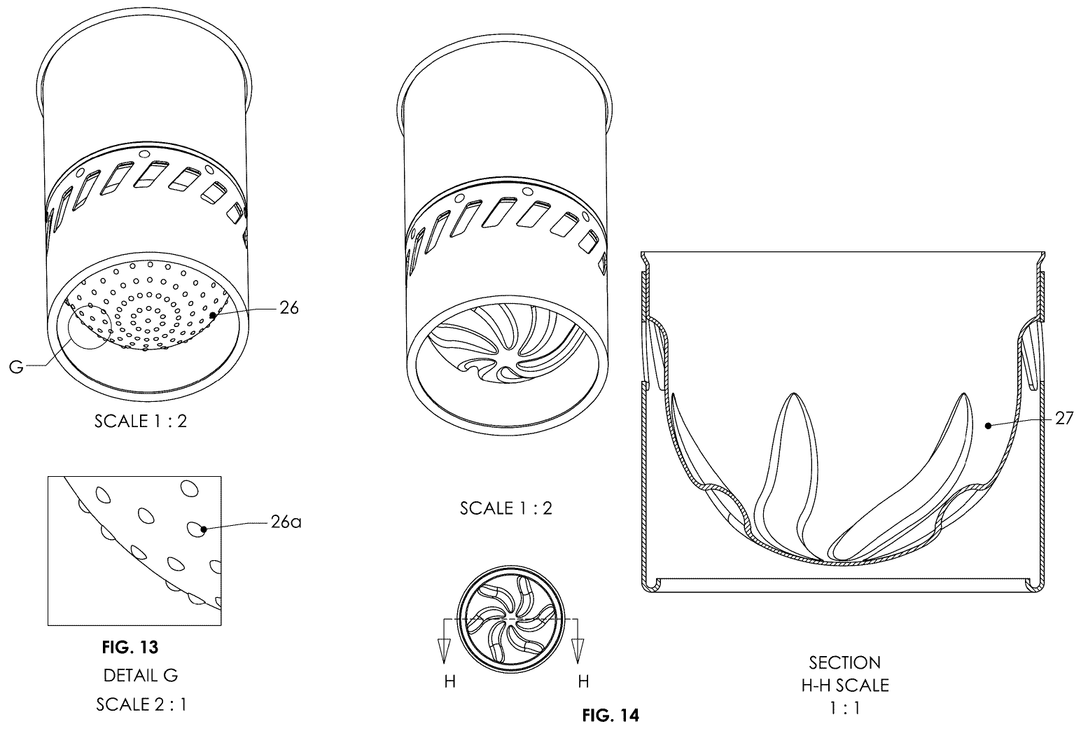

The pot 26 as illustrated in FIG. 13, shown from a perspective view and blown-up detail area G, has a rounded bottom similar to pot 1 but includes a plurality of raised bumps 26a on the surface of the bottom and sides within the containment volume 7, which serve to produce turbulence on the surface that further increases efficiency. Similarly, indented dimples (not shown but just the inverse of the bumps in FIG. 13) in place of the raise bumps would also have a turbulence producing effect and also serve to further increase efficiency.

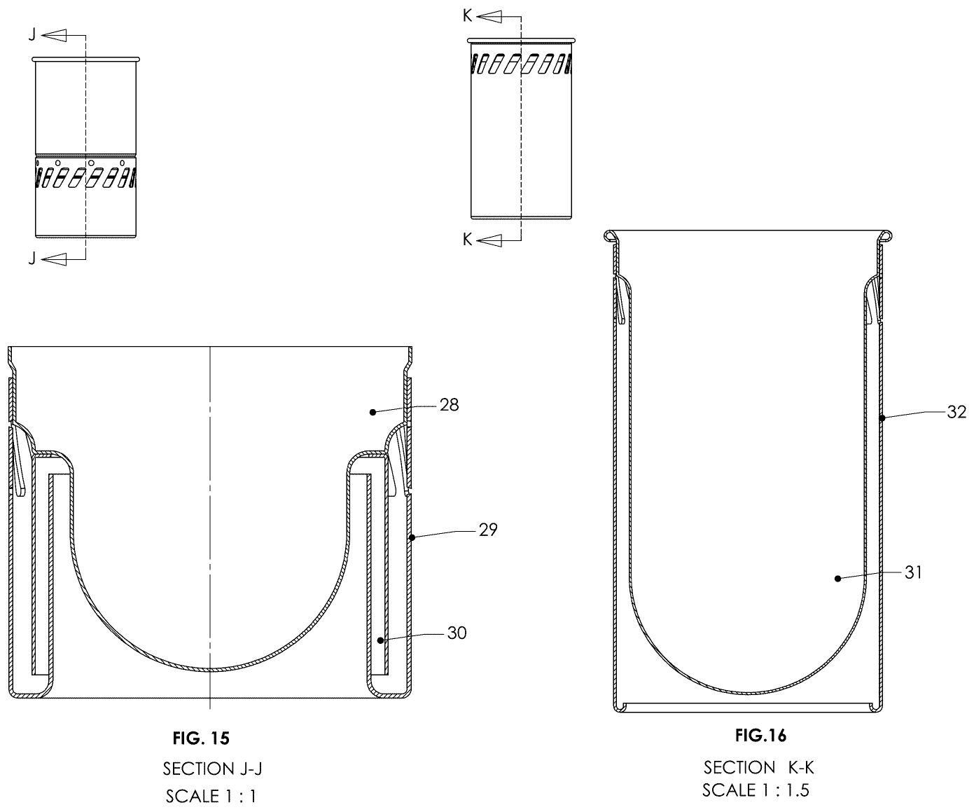

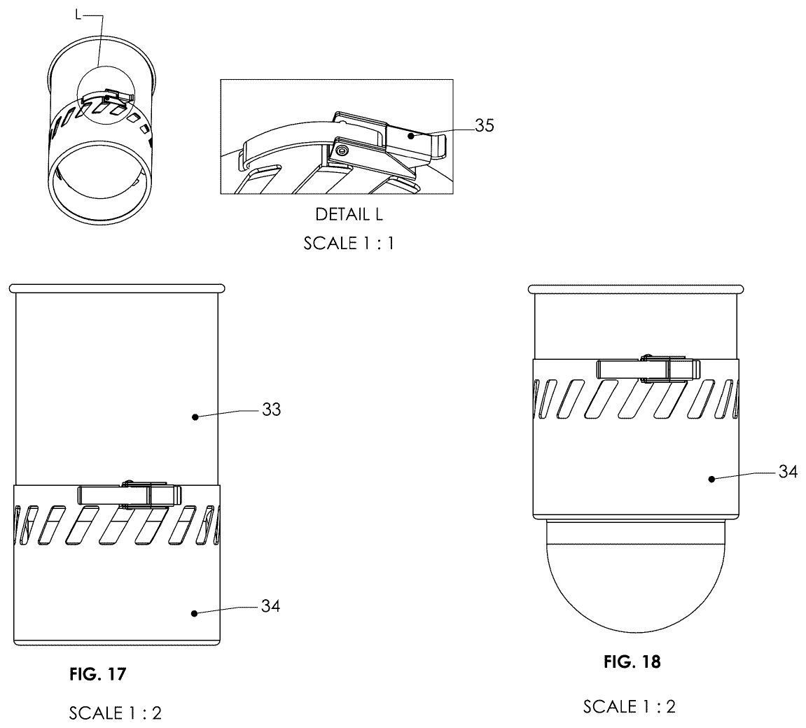

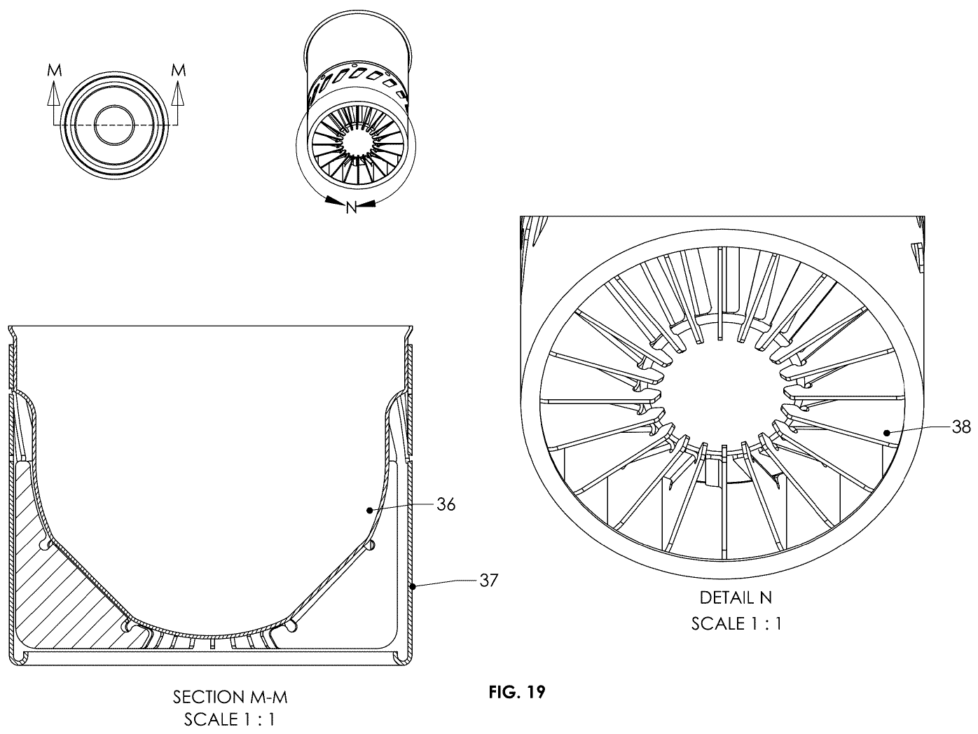

The pot 27 of FIG. 14, shown from a perspective view, a bottom view and a cross-sectional view along H-H, includes additional shapes in the form of curved grooves and/or protrusion in the bottom and at least a portion of the side of the pot 27 that may serve to increase surface area and therefore boil time and efficiency. The pot 28 of FIG. 15, shown from a side view and a cross-sectional view along J-J, includes a largely hemispherical shape, along with a containment ring 29 that includes a number of flow channels 30 that cause the hot exhaust gas to travel a longer flow path, which serves to also increase surface area. Similarly, the pot 31 of FIG. 16, shown from a side view and a cross-sectional view along K-K, is also similar to pot 1 only both the pot 31 and a containment ring 32 enable the exhaust to travel farther up the side of the pot 31, where it exits near the top of the assembly. The pot 31 may include a step like the pots shown in FIGS. 1-6. The containment ring 32 may also include a step.

The pot 33 and containment ring 34 of FIGS. 17 and 18, shown in perspective view and side five, along with blown up detailed view L, illustrate a shroud 34 that can slide up and down along the sides of the pot 33 so as to enable a smaller packed size when not in use and to properly position the containment ring when in use. A latch assembly 35 secures the shroud to the pot when in use and when packed for travel. FIG. 17 illustrates the shroud 34 when in an operating position while FIG. 18 shows the shroud 34 in a storage position. A secondary advantage of the sliding shroud design is that the shroud 34 can be slid further down relative to the pot when in use, which may increase wind protection. In such a case, the bottom or the pot and the stove burner would remain the same distance apart.

The pot 36 and shroud 37 of FIG. 19, shown in a perspective view with area N blown up in detail and a top view with a cross-sectional view along M-M, continues to take advantage of the combination of a pot 36 with a rounded bottom and containment volume 7 around the bottom and side of the pot 36 created by the shroud 37 but adds the fins 38, as a heat exchanger, to the design. While the pot 36 has a hemispherical or rounded bottom, it also introduces flattened areas 38 as part of the outer surface. In addition, while the fins 38 are a heat exchanger, this embodiment may be used with a radiant burner stove. The positioning and structure of the flattened areas 38 at the bottom of the pot 36, close to the burner (not shown in FIG. 19), allow the exhaust gas to vent up and along the sides of the pot within the containment volume 7.

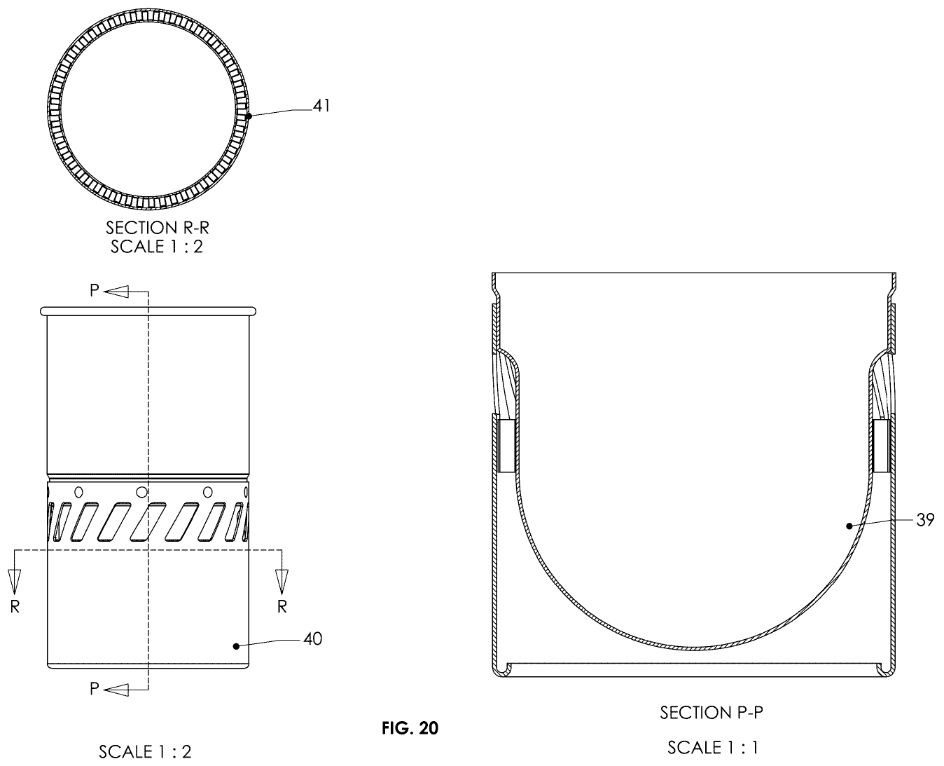

The pot 39 and shroud 40 of FIG. 20, shown in a side view and cross-sectional view along P-P, also employ a rounded bottom and heat exchanger fins. In FIG. 20, the pot 39 is smoothly hemispherical like that of pot 1, but a set of heat exchanger fins 41 are positioned around an upper area above the combustion region just below the opening 4 (as shown in FIG. 1). The heat exchanger fins are positioned above the combustion region so as to not disrupt the combustion reaction. This allows heat escaping the containment volume 7 to transfer more heat to pot 39 that otherwise would be lost to atmosphere, therefore further increasing efficiency.

Further embodiments, not shown per se, but represented via different combinations of the components of the embodiments that are illustrated in FIGS. 1-20, include a pot with a hemispherical or rounded bottom, and with pot 1, and an annular area above the combustion region similar to the location of the fins in FIG. 20, but in the form of a step in the shroud instead of a step in the pot, such as shroud bottom 12 of FIG. 5, at the pot interface at the top of the shroud.

In a further embodiment, the pot may have a hemispherical bottom with no annular area (i.e., not a step in either the pot or the shroud) between the shroud and the pot such that the shroud is tight to the pot diameter.

In another embodiment, the pot may have a hemispherical bottom with a shroud that has an annular area between the pot and the shroud, but with no step in the pot or the shroud, but connected by some other means than welds, etc., such as by tabs that bend in on the shroud or some other means of attachment.

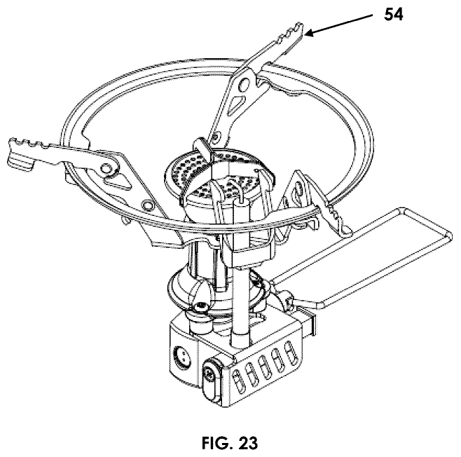

FIG. 21 further illustrates the stove 11 first shown in FIG. 5. The stove 11 includes a mount 15 that connects to the stove and may provide an interface with the ring bottom 12 of the containment ring 2 via pot interface ring 50. Each of the mounts 15 may be welded to the pot interface ring 50 via mount weld tabs 52, thereby making the mounts stationary. A leg 54 may be connected to a mount 15 via a pivot 56, which may be formed using a step rivet. A push tab 58 may be used to rotate the leg 54 relative to mount 15 from a stored position, as shown in FIG. 21 and FIGS. 22A and 22B, to a deployed position, as shown in FIGS. 23 and 24. A stop tab 60 on the mount prevents the leg from over rotating when moved from the deployed position to the stored position and a dimple 62 retains the leg in the stored position as the stove 11 is moved about.

FIG. 22A illustrates the stove of FIG. 21 without a containment ring 2 of a pot placed on the pot interface ring 50. As shown, an upper portion 64 of the stand 15 extends up into an area above the pot interface ring 50 so as to allow the legs to rotate to a flat position when deployed as further illustrated in FIG. 23. FIG. 22B further illustrates the area F of FIG. 22A. The pot interface ring 50 includes ring web tabs 66 that correspond to each of the mount weld tabs 52 that are welded in place on the bottom surface of the pot interface ring 50. FIG. 22B also further illustrates that each of the legs 54 includes an arrow 68 indicating the direction of rotation of each leg 54. FIG. 23 illustrates the legs 54 when fully deployed and FIG. 24 illustrates an alternative cooking pot 70 with a traditional flat bottom positioned on the legs 54 when fully deployed. FIG. 24 also illustrates how a gas canister 72 may be connected to the stove 11 when in use.

In an embodiment, a cooking assembly, comprising: a pot having cylindrical vertical sides, an open circular top and a closed at least partially rounded bottom; and a cylindrical containment ring positioned around a portion of the pot creating a containment volume between the containment ring and the pot, the containment ring including an open circular bottom receiving a portable stove when configured for cooking, holding the pot in a vertical orientation, and letting flame from the portable stove and air to flow freely into the containment volume so as to reduce back pressure and increase heating efficiency, without disrupting combustion reactions; the containment ring further including a plurality of vent holes at an upper area of the containment volume letting combustion gases escape freely.

In the embodiment, wherein the vent holes are formed below a connection between the pot and the containment ring.

In the embodiment, wherein the containment ring includes a plurality of webs, each web among the plurality of webs formed between the vent holes, and wherein the plurality of webs does not impinge the flame from the portable stove.

In the embodiment, wherein the webs have a cross-sectional area sufficient to enable heat transfer from the entirety of the containment ring to the pot.

In the embodiment, wherein the containment ring is thermally and structurally connected to the pot to promote heat transfer.

In the embodiment, wherein the containment ring is structurally connected to the pot by a series of welds.

In the embodiment, wherein the containment ring is structurally connected by a tight fit between the containment ring and the pot.

In the embodiment, wherein the containment ring is structurally connected to the pot by at least one of a series of welds and a tight fit between the containment ring and the pot.

In the embodiment, wherein an outer diameter of the pot steps down to create an annular space near the upper area of the containment volume.

In the embodiment, further comprising a plurality of fins within the annular space below the plurality of vent holes.

In the embodiment, wherein the portable stove includes a mount connected to a pot interface ring that interfaces with the pot and promotes location of the pot between the plurality of mounts.

In the embodiment, wherein the mounts are rigid and do not fold.

In the embodiment, wherein the containment ring steps down in diameter from a first diameter of an upper portion of the containment ring to a second diameter of a lower portion of the containment ring.

In the embodiment, wherein the lower portion of the containment ring includes a plurality of air openings.

In the embodiment, further comprising an insulated collar that surrounds an upper portion of the pot and a handle.

In the embodiment, wherein the containment ring includes a plurality of air holes at the upper portion of the containment ring under the handle reducing back pressure and exhaust exiting the containment volume in an area under the handle.

In the embodiment, wherein the pot and the containment ring are formed of anodized aluminum.

In the embodiment, wherein the at least partially rounded bottom has a shape that is one of hemispherical, ellipsoidal, paraboloid, and a combination thereof.

In the embodiment, wherein the rounded bottom includes a plurality of raised bumps on a surface of the rounded bottom.

In the embodiment, wherein the rounded bottom includes a plurality of indented dimples on a surface of the rounded bottom.

In the embodiment, wherein the rounded bottom includes a plurality of curved grooves on a surface of the rounded bottom.

In the embodiment, wherein the rounded bottom includes a plurality of curved protrusions on a surface of the rounded bottom.

In the embodiment, wherein the containment ring includes a series of flow channels between the containment volume and outer sides of the containment ring for hot exhaust gas to travel along a longer flow path.

In the embodiment, wherein the containment ring is configured to slide up and down along the vertical sides of the pot and includes a latch assembly for securing the containment ring to the vertical sides of the pot.

In the embodiment, wherein the containment ring includes a plurality of fins at the open circular bottom of the containment ring that radiate outward from a smaller diameter central area.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A cooking assembly, comprising:
a pot having cylindrical vertical sides, an open circular top and a closed at least partially rounded bottom; and
a cylindrical containment ring positioned around a portion of the pot creating a containment volume between the containment ring and the pot, the containment ring including an open circular bottom receiving a portable stove when configured for cooking, holding the pot in a vertical orientation, and letting flame from the portable stove and air to flow freely into the containment volume to increase heating efficiency, without disrupting combustion reactions;
wherein the containment ring further including a plurality of vent holes at an upper area of the containment volume letting combustion gases escape freely.

2. The cooking assembly of claim 1, wherein the vent holes are formed below a connection between the pot and the containment ring.

3. The cooking assembly of claim 1, wherein the containment ring includes a plurality of webs, each web among the plurality of webs formed between the vent holes, and wherein the plurality of webs does not impinge the flame from the portable stove.

4. The cooking assembly of claim 3, wherein the webs have a cross-sectional area sufficient to enable heat transfer from the containment ring to the pot.

5. The cooking assembly of claim 1, wherein the containment ring is thermally and structurally connected to the pot to promote heat transfer.

6. The cooking assembly of claim 5, wherein the containment ring is structurally connected to the pot by a series of welds.

7. The cooking assembly of claim 5, wherein the containment ring is structurally connected by a tight fit between the containment ring and the pot.

8. The cooking assembly of claim 1, wherein the containment ring is structurally connected to the pot by at least one of a series of welds and a tight fit between the containment ring and the pot.

9. The cooking assembly of claim 1, wherein an outer diameter of the pot steps down to create an annular space near the upper area of the containment volume.

10. The cooking assembly of claim 9, further comprising a plurality of fins within the annular space below the plurality of vent holes.

11. The cooking assembly of claim 1, wherein the portable stove includes a mount connected to a pot interface ring that interfaces with the pot and promotes location of the pot on the mount.

12. The cooking assembly of claim 11, wherein the mounts are rigid and do not fold.

13. The cooking assembly of claim 1, wherein the containment ring steps down in diameter from a first diameter of an upper portion of the containment ring to a second diameter of a lower portion of the containment ring.

14. The cooking assembly of claim 13, wherein the lower portion of the containment ring includes a plurality of air openings.

15. The cooking assembly of claim 1, further comprising an insulated collar that surrounds an upper portion of the pot.

16. The cooking assembly of claim 1, further comprising a handle.

17. The cooking assembly of claim 16, wherein the containment ring includes a plurality of air holes at the upper portion of the containment ring under the handle that allow exhaust to exit the containment volume.

18. The cooking assembly of claim 1, wherein the pot and the containment ring are formed of anodized aluminum.

19. The cooking assembly of claim 1, wherein the at least partially rounded bottom has a shape that is one of hemispherical, ellipsoidal, paraboloid, and a combination thereof.

20. The cooking assembly of claim 1, wherein the rounded bottom includes a plurality of raised bumps on a surface of the rounded bottom.

21. The cooking assembly of claim 1, wherein the rounded bottom includes a plurality of indented dimples on a surface of the rounded bottom.

22. The cooking assembly of claim 1, wherein the rounded bottom includes a plurality of curved grooves on a surface of the rounded bottom.

23. The cooking assembly of claim 1, wherein the rounded bottom includes a plurality of curved protrusions on a surface of the rounded bottom.

24. The cooking assembly of claim 1, wherein the containment ring includes a series of flow channels between the containment volume and outer sides of the containment ring for hot exhaust gas to travel along a longer flow path.

25. The cooking assembly of claim 1, wherein the containment ring is configured to slide up and down along the vertical sides of the pot and includes a latch assembly for securing the containment ring to the vertical sides of the pot.

26. The cooking assembly of claim 1, wherein the containment ring includes a plurality of fins at the open circular bottom of the containment ring that radiate outward from a smaller diameter central area.
